(19) United States
(12) Patent Application Publication
(10) Pub. No.: US 2026/0338523 A1
(43) Pub. Date: Oct. 29, 2026

(54) AN IGNITER FOR IGNITING EXPLOSIVES OR PYROTECHNIC COMPOSITION

(71) Applicant: SAAB AB, Linköping (SE)

(72) Inventor: Pontus TÖRNBERG, Karlskoga (SE)

(21) Appl. No.: 19/112,415

(22) PCT Filed: Sep. 18, 2023
(86) PCT No.: PCT/SE2023/050912

§ 371 Date: Mar. 17, 2025

(30) Foreign Application Priority Data
Sep. 19, 2022 (SE) 2200103-6

(51) Int. Cl. F42B 3/14

(52) U.S. Cl. CPC F42B 3/14

(57) ABSTRACT

An igniter, for igniting explosives or pyrotechnic composition, including a container for housing explosives or pyrotechnic composition; and an electronic circuitry including, two conducting electrodes, each having a first end and a second end. Each first end is located inside the container, electromotive force (EMF) source. Each second end of the electrodes being arranged to be connected to the EMF source, and a control circuit. The control circuit is configured to, based on obtained data, determine if a predetermined condition is fulfilled, and the control circuit is arranged to connect the EMF source with each second end of the conducting electrodes. Each first end of the conducting electrodes is arranged to, upon obtaining EMF, provide energy into the container. The container and the electronic components of the electronic circuitry are at least partly integrated.

### TECHNICAL FIELD

The present disclosure relates to an igniter. More specifically, the disclosure relates to an igniter as defined in the introductory parts of the independent claims.

### BACKGROUND ART

Pyrotechnic initiators, e.g., bridgewire technology is often used to ignite other materials, which is more sensitive for mechanical load.

A problem with the solutions of the prior art is fault related to detonation, i.e., unintentional detonation, and explosives that does not detonate at all. These faults may be caused since the igniter ignite at relatively low energy, and the fact that prior art solution is sensitive to, for example, electrostatic discharge (ESD), shock sensitive, temperature sensitive, i.e., sensitive to cold weather, and/or not hermetically sealed.

There is thus a need for an improved ignition system.

### SUMMARY

It is an object of the present disclosure to mitigate, alleviate or eliminate one or more of the above-identified deficiencies and disadvantages in the prior art and solve at least the above mentioned problem. According to a first aspect there is provided an igniter, for igniting explosives and/or pyrotechnic composition, comprising a container for housing explosives and/or pyrotechnic composition; and an electronic circuitry comprising,
two conducting electrodes, each having a first end and a second end, wherein each first end is located inside the container,
an electromotive force, EMF, source, wherein each second end of the electrodes is arranged to be connected to the EMF source, and
a control circuit, wherein said control circuit is configured to, based on obtained data, determine if a predetermined condition/criteria for ignition is fulfilled, and the control circuit is arranged to connect the EMF source with said each second end of the conducting electrodes; wherein, each first end of the conducting electrodes is arranged to, upon obtaining EMF, provide energy into said container; and wherein the container and the electronic components of the electronic circuitry are at least partly integrated.

In other words, the container and the electronic components of the electronic circuitry are partly integrated such that they define a common body.

This design has a plurality of advantages. For example that reduced currents between the electric circuits and the container. Other advantages are reduced ESD sensitivity, less expensive, improved sealing, reduced shock sensitivity, reduced temperature sensitive, i.e., sensitive to cold weather, less complex construction. Preferably, the first ends are exposed in said container, i.e., they are exposed at an inner surface of the container, thereby defining a gap between them. The gap has the advantages of reducing the risk of malfunction ignition of an explosive or pyrotechnic composition.

A further advantages is that the claimed igniter can use more environmentally friendly explosives, e.g. silverazide compared to less environmentally friendly explosives e.g., leadazide. Put differently, prior solutions which are using the more environmental friendly silverazide has shown increased fault and malfunction during cold weather in comparison to leadazide. This has led to the use of the latter despite the fact that leadazide is less environmental friendly. Further, the European Union regulation REACH (Registration, Evaluation, Authorisation and Restriction of Chemicals) has declared restrictions regarding some chemicals, e.g., leadazide.

In one example embodiment, when the control circuit, based on obtained data, has determined that a predetermined conditions/criteria is fulfilled, the control circuit is configured to delay a triggering signal, before enabling detonation, e.g., the control circuit delays a triggering signal before letting the igniter be ignited.

According to some embodiments, the first ends of the conducting electrodes are separated by a distance defining a gap, wherein said distance is in the range of 1-15 mm, preferably 1-5 mm.

According to some embodiments, said electronic circuitry is mounted on a printed Circuit Board, PCB.

This has the advantages of improved production, e.g., mass production, and reduced cost. The electronic circuitry mounted on a PCB could be printed using 3D-printing technology (also known as additive manufacturing) which also improves the production procedure.

According to some embodiments, the igniter comprises a housing encapsulating the PCB, the EMF-source and at least a part of the container.

This has the advantage that the igniter, including said electronic circuitry, is covered and thereby protected from the outside environment. This lead to a more robust construction. According to some embodiments, the EMF source comprises a capacitor and/or a transformer.

This has the advantage that the ignition of the igniter can be controlled by said capacitor and/or a transformer. In other words, the igniter will not be ignited before a predetermined threshold level of voltage is reached.

In some embodiment the EMF source is a controllable power source. A controllable power source can be any type of energy source that can be controlled, e.g. the controllable power source can comprise a battery.

According to some embodiments, the igniter comprises explosives and/or pyrotechnic composition housed in said container.

According to some embodiments, the container houses a pyrotechnic composition.

This has the advantage that the igniter, can be used in situation where a detonation is not desired, e.g., as an igniter for air-bags in vehicles.

According to some embodiments, the container houses a primary explosive and a secondary explosive, wherein the conducting electrodes are configured to ignite the primary explosive, and the primary explosive is configured to ignite the secondary explosive.

In another example embodiment, the container houses a primary explosive, wherein the conducting electrodes are configured to ignite the primary explosive, and the primary explosive is further configured to ignite a secondary explosive located outside the container.

According to some embodiments, each first end of the conducting electrodes is arranged to, upon obtaining EMF, generate a spark between said first ends of the conducting electrodes

According to some embodiments, the igniter comprises at least one sensor, wherein said sensor(s) is connected to said control circuit, and configured to provide, to said control circuit data for determining if a predetermined conditions/criteria is fulfilled.

According to one embodiment, said predetermined condition is at least one of a pressure (for example measured by measuring activation of a piezoelectric crystal) or a predetermined position or change of position of a grenade carrying the igniter in relation to a gun barrel (for example indicating that the grenade carrying said igniter has passed through a gun barrel, which indicates that the grenade has been fired).

According to one embodiment, the igniter comprises a sensor configured to determine the EMF of the EMF source. For a predetermined explosive to be ignited by the igniter, the EMF may be too low. The control circuit may therefore be configured to indicate if the EMF of the EMF source is below a predetermined threshold value.

According to one embodiment, the sensor is a sensor configured determine whether or not the grenade, which comprising said igniter, is located at a safe distance or safe location, e.g., that the grenade has passed thru a gun barrel or is located inside said gun barrel. This provide improved safety, and reduce the risk of undesirable detonation.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### Terminology

The term spark gap igniter is to be interpreted as an igniter uses a spark gap which comprises two electrically conducting electrodes (in this application, interchangeably referred to as conducting electrodes, or simply conductors) separated by a gap. The gap may be filled with gas e.g., air, designed to allow an electric spark to pass between the conductors. The spark generates energy, e.g., heat.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1a-1b shows a perspective of the igniter according to an embodiment of the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

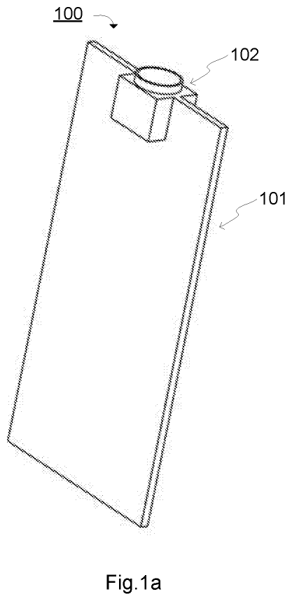

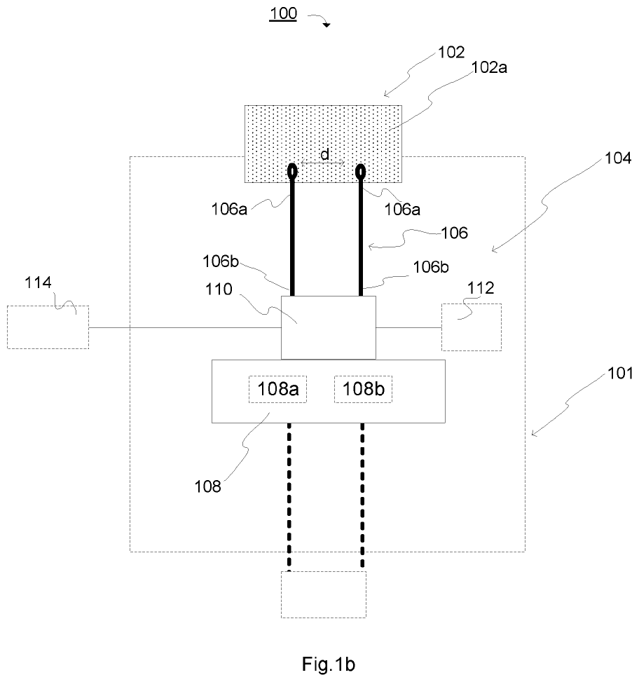

FIG. 1a shows perspective of the igniter 100 according to an embodiment of the present disclosure. In the figure the container 102 is partly integrated in the PCB 101 comprising the electronic components.

### FIG. 1b Shows Perspective of the Igniter 100 According to an Embodiment of the present disclosure.

The first aspect of this disclosure shows an igniter 100, for igniting explosives and/or pyrotechnic composition. The igniter 100 comprising a container 102 for housing explosives and/or pyrotechnic composition 102a (indicated by dots inside container 102). The igniter 100 also comprises electronic circuitry 104 comprising two conducting electrodes 106. Each conducting electrodes 106 having a first end 106a and a second end 106b. Each first end 106a is located inside the container 102. The electronic circuitry 104 further comprising an electromotive force, EMF, source, 108, wherein each second end 106b of the electrodes 106 being arranged to be connected to the EMF source 108. The electronic circuitry 104 further comprises a control circuit 110. The control circuit 110 is configured to, based on obtained data, determining if a predetermined conditions/criteria is fulfilled. The control circuit 110 is further configured to connect the EMF source 108 with said each second end 106b of the conducting electrodes 106. The first ends 106a of the conducting electrodes 106 are arranged via at least one through hole into said container 102 (not shown).

Each first end 106a of the conducting electrodes 106 are arranged to, upon obtaining EMF, provide energy, e.g., heat or radiation, into the container 102. The electronic components of the electronic circuitry 104, and the container 102 are partly integrated. In other embodiments the PCB 101, comprising the electronic components, and the container 102 are completely integrated. The conducting electrodes are arranged via at least one through hole into said container (not shown).

The second ends of the conducting electrodes are separated by a distance d defining a gap is 2.0 mm.

Said electronic circuitry 104 is mounted on a printed Circuit Board, PCB, 101.

The EMF source 108 comprises a capacitor 108a and/or a transformer 108b.

The container 102 for housing explosives and/or pyrotechnic composition comprises explosives 102a (illustrated as dots).

The explosives comprises a primary explosive and a secondary explosive, and wherein the conducting electrodes are configured to ignite the primary explosives, and the primary explosives is configured to ignited secondary explosive.

The igniter 100 further comprises an internal sensor 112 and an external sensor 114, wherein said sensors 112, 114 are connected to said control circuit 110, and configured to provide, to said control circuit 110 data for determining if a predetermined conditions/criteria is fulfilled

The person skilled in the art realizes that the present disclosure is not limited to the preferred embodiments described above. The person skilled in the art further realizes that modifications and variations are possible within the scope of the appended claims. For example. Additionally, variations to the disclosed embodiments can be understood and effected by the skilled person in practicing the claimed disclosure, from a study of the drawings, the disclosure, and the appended claims.

1-9. (canceled)

10. An igniter, for igniting explosives and pyrotechnic composition, comprising a container for housing explosives and pyrotechnic composition; and an electronic circuitry comprising,
two conducting electrodes, each having a first end and a second end, wherein each first end is located inside the container,
an electromotive force (EMF) source, wherein each second end of the electrodes being arranged to be connected to the EMF source, and
a control circuit, wherein said control circuit is configured to, based on obtained data, determining if predetermined conditions/criteria are fulfilled, and the control circuit is arranged to connect the EMF source with said each second end of the conducting electrodes; wherein, each first end of the conducting electrodes is arranged to, upon obtaining EMF, provide energy into said container; and wherein the container and electronic components of the electronic circuitry are at least partly integrated such that they define a common body, wherein, the first ends of the conducting electrodes are separated by a distance (d) defining a gap, wherein said distance (d) is in the range of 1-15 mm, preferably 1-5 mm, wherein each first end of the conducting electrodes is arranged to, upon obtaining EMF, generate a spark between said first ends of the conducting electrodes.

11. The igniter according to claim 10, wherein said electronic circuitry is mounted on a printed Circuit Board (PCB).

12. The igniter according to claim 10, further comprising a housing encapsulating the igniter.

13. The igniter according to claim 10, wherein the EMF source further comprises a capacitor and/or a transformer.

14. The igniter according to claim 10, wherein the igniter comprises explosives or pyrotechnic composition housed in said container.

15. The igniter according to claim 14, wherein the container for explosives or pyrotechnic composition comprises explosives, wherein the explosives comprise a primary explosive and a secondary explosive, and wherein the conducting electrodes are configured to ignite the primary explosive, and the primary explosive is configured to ignite the secondary explosive.

16. The igniter according to claim 10, further comprising at least one of an internal sensor and/or an external sensor, wherein said sensor(s) is connected to said control circuit, and configured to provide to said control circuit data for determining if the predetermined conditions/criteria are fulfilled.
